(19) United States
(12) Patent Application Publication
(10) Pub. No.: US 2022/0315811 A1
(43) Pub. Date: Oct. 6, 2022

(54) HMPSA CROSSLINKABLE UNDER UV IRRADIATION

(71) Applicant: BOSTIK SA, Colombes (FR)

(72) Inventors: Amandine RAFAITIN, VENETTE (FR); Alexandre GOURLAIN, VENETTE (FR); Christophe ROBERT, VENETTE (FR)

(21) Appl. No.: 17/618,048

(22) PCT Filed: Jul. 6, 2020
(86) PCT No.: PCT/FR2020/051197

§ 371 Date: Dec. 10, 2021

(30) Foreign Application Priority Data
Jul. 10, 2019 (FR) FR1907762

(51) Int. Cl. C09J 157/02; C09J 7/38

(52) U.S. Cl. CPC C09J 157/02; C09J 7/387; C09J 2301/416; C09J 2301/414; C09J 2301/124; C09J 2301/304

(57) ABSTRACT

A UV-crosslinkable HMPSA composition comprises 10-24% by weight of a block copolymer comprising a styrenic block and a polybutadiene block comprising at least 25% by weight of the 1,2-vinyl unit; 43-65% by weight of a tackifying resin obtained by polymerization, then complete or partial hydrogenation of a C9 fraction, having a softening point of 80-150° C.; 10-25% by weight of a petroleum-derived hydrocarbon oil; and an appropriate amount of a photoinitiator (D). A self-adhesive article comprises a carrier layer (b) coated with a self-adhesive layer (a) comprising the HMPSA composition in the crosslinked state.

The present invention pertains to a UV-crosslinkable hotmelt pressure sensitive adhesive (HMPSA) composition and to a self-adhesive article comprising an adhesive layer consisting of said crosslinked composition. Said article is useful more particularly for manufacturing self-adhesive labels and/or tapes, and advantageously possesses an adhesive strength which can be maintained within a broad temperature range. The invention lastly pertains to a method for manufacturing said article.

Pressure sensitive adhesives (PSAs) are substances which confer, on the carrier which is coated with them, an immediate tack at ambient temperature, allowing it to adhere instantaneously to a substrate under the effect of a gentle and brief pressure. PSAs are employed for the manufacture of self-adhesive tapes having varied uses. Mention may be made, for example, besides the transparent adhesive tape widely used in daily life, of the forming and the assembling of cardboard packages; the protection of surfaces for painting operations, in the building industry; the securement of electric cables in the transportation industry; and the bonding of fitted carpets by double-sided adhesive tapes. PSAs are also used for the manufacture of self-adhesive labels which are attached to articles for the purpose of presenting information (such as barcode, name, price) and/or for decorative purposes.

For the purpose of the manufacture of self-adhesive labels and/or tapes, PSAs are often applied by continuous coating processes over the whole of the surface of a large-sized carrier layer (which may be printable), in an amount (generally expressed in g/m²) denoted below by the term “surface weight”. The carrier layer consists for example of paper or of film of a polymeric material having one or more layers. The adhesive layer which covers the carrier layer may itself be covered with a protective nonstick layer (often called release liner), consisting for example of a silicone film. The multilayer system obtained is generally packaged by winding in the form of large reels having a width of up to 2 m and having a diameter of up to 1 m, which can be stored and transported.

These multilayer systems may be subsequently converted into self-adhesive tapes by slitting and packaging as rolls of predetermined width and length.

These multilayer systems may also be converted into self-adhesive labels which can be applied by the end user, by means of transformation processes which include the printing of desired informative and/or decorative elements onto the printable face of the carrier layer, followed by cutting to the desired shape and sizes. The protective nonstick layer can be easily removed without modifying the adhesive layer, which remains attached to the carrier layer. After separation from its nonstick protective layer, the label is applied to the article to be coated either manually or with the aid of labelling machines on automated packaging lines.

PSAs, owing to their high ambient-temperature tack, enable rapid holding or attachment of the self-adhesive tape and/or label to the substrate (or article) to be coated (for example, as regards tapes, on packaging boards to be formed, or else, as regards labels, on bottles), suitable for the achievement of high industrial production rates.

There exists a field of application of PSAs for which it is desirable for the adhesive strength of the tapes and/or labels on the substrate to be also maintained when the adhesive joint providing the attachment is exposed (likewise, consequently, the article coated with the tape and/or the label) to a temperature capable of varying within a wide range. Mention may also be made, for example, of the use of self-adhesive tapes for assembling components for which good heat resistance is necessary, as in the case, for example, of the interior trim of aircraft or other vehicles. Mention may also be made of the positioning of labels on certain elements of automobiles (or other vehicles) located close to the engine, or on packaging designed to receive a hot liquid during processing, or else on articles (such as tires) which are labeled when hot, on leaving the manufacturing lines.

Hotmelt pressure sensitive adhesives (HMPSAs) are substances, solid at ambient temperature and substantially free of solvents and water, which are deposited (or coated) on a carrier in the melted state, and provide the latter, after cooling, with a high tack and high adhesive strength on varied substrates.

However, the corresponding compositions generally comprise a thermoplastic polymer, such as a styrenic block copolymer (designated below by SBC), so that the adhesive joint securing the carrier to the substrate does not at high temperature entirely provide the strength (or cohesion) needed for the field of application targeted above.

UV-crosslinkable hotmelt pressure sensitive adhesive compositions are already known in the prior art as being strong at high temperature.

For instance, Kraton's patent application EP 1 123 362 B1 describes an adhesive composition which comprises a specific styrenic block copolymer in combination with a tackifying resin and a completely or partially saturated oil. Said copolymer comprises a polybutadiene block which in turn comprises at least 25% by weight of the 1,2-vinyl unit. This composition is UV-crosslinkable and possesses high adhesive strength as well as its high-temperature strength.

International patent application WO 01/55276 by FULLER describes an adhesive composition crosslinkable by UV radiation, which comprises a specific styrenic block copolymer, a tackifying resin and a plasticizer. As well as a styrenic end block, said copolymer comprises a middle block in the form of a conjugated diene, preferably 1,3-butadiene and/or isoprene, which is modified with a pendant 1,2-vinyl group on the main chain of said middle block, at a concentration enough for said copolymer to crosslink by exposure to a source of radiation.

U.S. Pat. No. 6,887,919 B2 by TESA describes a pressure sensitive adhesive composition comprising a first SBC with a styrenic block content of greater than 20% by weight, mixed with a styrenic block copolymer crosslinkable by UV exposure, especially an SBC having an elastomer block containing more than 30% by weight of the 1,2-vinyl unit.

It is an aim of the present invention to provide a UV-crosslinkable HMPSA composition which, after being coated onto a carrier and then crosslinked, leads to a pressure sensitive adhesive that possesses improved tack and adhesive strength properties.

Another aim of the invention is that the adhesive joint securing the resultant self-adhesive carrier to the substrate is stable at higher temperature, in other words retaining the required cohesion over a wide temperature range, including for high PSA surface weights.

Such aims are especially desirable with a view to the use of said HMPSA composition for obtaining high-performance pressure sensitive adhesive tapes (or labels).

UV-Crosslinkable Hotmelt Pressure Sensitive Adhesive Composition:

The invention accordingly first provides a UV-crosslinkable hotmelt pressure sensitive adhesive (HMPSA) composition comprising, based on the total weight of said composition:
from 10% to 24% by weight of a block copolymer (A) which comprises at least:
   a block A1 consisting of a repeating unit of aromatic hydrocarbon substituted by a vinyl group, and
   a polybutadiene block A2 comprising at least 25% by weight of the 1,2-vinyl unit, based on the total weight of said polybutadiene block;
from 43% to 65% by weight of a tackifying resin (B) obtained by polymerization, then complete or partial hydrogenation of a petroleum-derived C9 fraction of unsaturated or aromatic hydrocarbons, said resin (B) having a softening point of from 80 to 150° C.;
from 10% to 25% by weight of a liquid plasticizer (C) consisting of a petroleum-derived, completely or partially saturated hydrocarbon oil; and
an appropriate amount of a photoinitiator (D).

Absent any indication to the contrary, the percentages used in the present text to express amounts correspond to weight/weight percentages.

It has been found that the composition according to the invention advantageously enables improved permanent adhesion of a polyethylene terephthalate (PET) carrier coated on a stainless steel substrate after said carrier has been coated at a rate of 60 g/m², then crosslinked by UV. This adhesion corresponds to an adhesiveness (measured by 180° peel test on stainless steel as described hereinafter) of advantageously more than 18 N/2.54 cm. The tack of this same carrier at ambient temperature (measured by instantaneous loop adhesion test on stainless steel as described hereinafter) is advantageously between 10 and 50 N/(2.54 cm)². Lastly, the bonded joint formed after application of this same carrier to a stainless steel substrate provides for its securement in a temperature range of up to at least 160° C., this temperature being evaluated by the test known as the Shear Adhesion Failure Temperature (or SAFT) test.

Block Copolymer (A):

The HMPSA composition according to the invention comprises from 10% to 24% by weight of a block copolymer (A) which comprises at least:
a block A1 consisting of a repeat unit of aromatic hydrocarbon substituted by a vinyl group, and
a polybutadiene block A2 comprising at least 25% by weight of the 1,2-vinyl unit, based on the total weight of said polybutadiene block.

According to one preferred variant, the block A1 is a styrenic block (or more specifically a polystyrene block). The block copolymer (A) preferably comprises two blocks A1. The amount of blocks A1 ranges from 10% to 50% by weight, preferably from 12% to 35%, based on the total weight of copolymer (A).

The polybutadiene block A2 comprises in its chain a repeating unit referred to as the 1,2-vinyl unit, of formula:

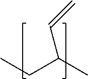

The amount by weight of the 1,2-vinyl unit in the polybutadiene block A2 is at least 25% by weight, based on the total weight of said polybutadiene block, and is preferably within a range of from 30% to 70% by weight, and more preferably still from 35% to 65% by weight.

The block copolymer (A) may be linear or radial and typically has the structure:
A1-A2-A1; or A1-A2; or else
(A1-A2)ₙY where n is an integer from 2 to 100, preferably from 2 to 20, more preferably from 2 to 6 and Y is the residue of a coupling agent.

Reference may be made, for ample information on the description and on the preparation of the block copolymer (A), to Kraton patent application EP 1123362B1 and to Shell U.S. Pat. No. 5,804,663.

A preferred block copolymer (A) is also available commercially under the name Kraton® D-KX222, which is a copolymer having a styrenic block A1 content of about 18% by weight and a polybutadiene block A2 content of about 82% by weight, based on the total weight of the copolymer (A). Said block A2 comprises about 57% by weight of 1,2-vinyl unit.

The HMPSA composition according to the invention comprises one or more block copolymers (A) as defined above. According to one embodiment, the HMPSA composition according to the invention comprises no thermoplastic polymer other than the one or more copolymers (A), and especially no styrenic block copolymer other than said block copolymer(s) (A).

According to one preferred embodiment, the amount of the block copolymer (A) in the HMPSA composition according to the invention is within a range of from 12% to 19% by weight, more preferably from 15% to 19%, and more preferably still from 15% to 18%.

Tackifying Resin (B):

The HMPSA composition according to the invention comprises from 43% to 65% by weight of a tackifying resin (B) obtained by polymerization, then complete or partial hydrogenation of a petroleum-derived C9 fraction of unsaturated or aromatic hydrocarbons, said resin (B) having a softening point of from 80 to 150° C.

According to a preferred variant, the one or more tackifying resins (B) used have a softening temperature of between 90 and 120° C., more preferably still between 95 and 105° C.

The softening temperature is determined in accordance with the standardized ASTM E 28 test, the principle of which is as follows. A brass ring with a diameter of approximately 2 cm is filled with the resin to be tested, in the melted state. After cooling to ambient temperature, the ring and the solid resin are placed horizontally in a thermostated glycerol bath with a temperature which can vary by 5° C. per minute. A steel ball with a diameter of approximately 9.5 mm is centered on the disk of solid resin. The softening temperature is that temperature, during the phase of temperature increase of the bath at a rate of 5° C. per minute, at which the disk of resin yields by a height of 25.4 mm under the weight of the ball.

Tackifying resins (B) are commercially available, and mention may be made for example of the following products:
Regalite® S1100 available from Eastman, which is a fully hydrogenated resin having a softening temperature of 100° C. and a weight-average molecular mass of 830 g/mol;
Regalite® S5100 available from Eastman, which is a partially hydrogenated resin having a softening temperature of 100° C. and a weight-average molecular mass of 900 g/mol; or else
Regalite® S7100 likewise available from Eastman, which is a partially hydrogenated resin having a softening temperature of 102° C. and a weight-average molecular mass of 900 g/mol.

According to a preferred variant, the HMPSA composition according to the invention comprises from 50% to 65% of tackifying resins, more preferably still from 55% to 65% by weight.

Liquid Plasticizer (C):

The HMPSA composition according to the invention comprises from 10% to 25% by weight of a liquid plasticizer (C) consisting of a petroleum-derived, completely or partially saturated hydrocarbon oil.

These oils are generally obtained from petroleum by various refining steps, including a catalytic hydrogenation as the last purification step. They generally have a very low aromatic carbon content (for example, less than 10% by weight, preferably less than 5%), a high paraffinic carbon content (for example, more than 50% by weight, preferably more than 60%), and a medium naphthenic carbon content (for example, of between 25% and 50% by weight).

According to a preferred variant, the liquid plasticizer (C) consists of an oil having an average molecular mass as measured by the ASTM D 2502 method of less than or equal to 2000 g/mol, preferably less than or equal to 1000 g/mol, and more preferably still less than or equal to 500 g/mol.

According to another preferred variant, the liquid plasticizer (C) used has a kinematic viscosity at 100° C. within a range from 7 to 11 mm²/s.

The oils which can be used as liquid plasticizer (C) are commonly available industrially; a particular instance is Primol® 352, from EXXONMOBIL, which has paraffinic, naphthenic and aromatic carbon contents respectively of about 68%, 32% and 0% by weight. The average molecular mass of Primol® 352 as measured by the ASTM D 2502 method is 480 g/mol, and the kinematic viscosity at 100° C. is 8.5 mm²/s.

According to a preferred variant, the HMPSA composition according to the invention comprises from 14% to 23% by weight of the liquid plasticizer (C).

Photoinitiator (D):

The HMPSA composition according to the invention comprises a photoinitiator (D), which is used to initiate the radical polymerization reaction taking place when the composition is exposed to radiation, especially to UV. Any photoinitiator known for this purpose may be used as compound (D), such as a benzophenone derivative.

Mention may be made especially of 2,2-dimethoxy-2-phenylacetophenone, which is sold for example by IGM Resins under the name Omnirad® BDK.

The composition may comprise such photoinitiators in an amount of from 0.05% to 3% by weight, preferably from 1% to 2.5%.

Liquid Polybutadiene Resin (E):

According to one embodiment, the HMPSA composition according to the invention may further comprise up to 25% by weight of a liquid polybutadiene (E) of low molecular mass.

According to a preferred variant, the number-average molecular mass Mn of the liquid polybutadiene (E) is within a range of from 1500 to 5500 g/mol, preferably from 2000 to 4500 g/mol.

According to another preferred variant, the liquid polybutadiene (E) has a Brookfield viscosity as measured at 45° C. of from 6 to 60 Pa·s, preferably from 10 to 40 Pa·s.

The polymerization of 1,3-butadiene may be performed according to a trans-1,4 addition or a cis-1,4 addition, resulting in a repeating unit in the copolymer chain (designated, respectively, by trans-1,4 and cis-1,4 butadiene unit), which is in the form of the two geometrical isomers having the respective formulae:

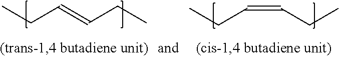

The polymerization of 1,3-butadiene may also be performed according to a 1,2-addition, resulting in a repeating unit in the copolymer chain (designated by 1,2-vinyl butadiene unit) which has the formula:

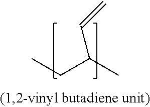

Thus the polybutadiene generally comprises in its chain the above three repeating units, designated hereinafter generically by “butadiene-derived units”.

According to a preferred variant, the liquid polybutadiene (E) comprises in its main chain the three units above, the amount of 1,2-vinyl butadiene units being greater than or equal to 60% by weight (based on the total weight of the three constituent units of the chain), preferably greater than or equal to 70%, more preferably still greater than or equal to 80%.

Liquid polybutadienes (E) are available industrially, as for example the resin Ricon® 152 from Cray Valley. The number-average molecular mass Mn of the resin Ricon® 152 is 2900 g/mol, its Brookfield viscosity as measured at 45° C. is 20 Pa·s, and its 1,2-vinyl butadiene unit content is about 80% by weight, based on the total weight of the three constituent units of the chain.

According to a more preferred embodiment, the HMPSA composition according to the invention may comprise up to 17% by weight of the liquid polybutadiene (E).

Stabilizers (F):

An amount of 0.1% to 5% of one or more stabilizers (F) (or antioxidants) is additionally preferably included in the HMPSA composition according to the invention. These compounds are introduced in order to protect the composition from degradation resulting from a reaction with oxygen which is liable to be formed by the action of heat, light or residual catalysts on certain starting materials, such as the tackifying resins. These compounds may include primary antioxidants, which trap free radicals and are generally substituted phenols, such as Irganox® 1010 from Ciba or Sumilizer® GS from Sumitomo. The primary antioxidants can be used alone or in combination with other antioxidants, such as phosphites, for instance Irgafos® 168 also from Ciba, or else with UV-stabilizers such as amines.

An amount of (F) of from 0.5% to 2% is preferred, and preferred more particularly still is from 0.5% to 1.5%.

Amount of Ingredients of the Composition:

According to one preferred variant, the HMPSA composition according to the invention comprises, and more particularly preferably consists essentially of:
from 12% to 19% by weight of the block copolymer (A);
from 50% to 65% by weight of the tackifying resin(s) (B); and
from 14% to 23% by weight of the liquid plasticizer (C).

According to a more preferred variant, the HMPSA composition according to the invention comprises, and still more particularly preferably consists essentially of:
from 15% to 19% by weight of the block copolymer (A);
from 55% to 65% by weight of the tackifying resin(s) (B);
from 14% to 23% by weight of the liquid plasticizer (C).

The viscosity of the HMPSA composition as measured by a Brookfield® RVT viscometer at 163° C. is between 0.5 and 20 Pa·s, preferably between 0.5 and 5 Pa·s. Such a viscosity is entirely suited to the nozzles used in the industrial units of the coaters for the coating thereof on a carrier layer.

The HMPSA composition according to the invention is prepared by simple mixing of its components at a temperature between 130° C. and 200° C., until a homogeneous mixture is obtained; the photoinitiator (D) is preferably added last to the mixture.

The required mixing techniques are well known to those skilled in the art.

Self-Adhesive Article:

The present invention also provides a self-adhesive article comprising a carrier layer (b) coated with a self-adhesive layer (a), characterized in that said self-adhesive layer (a) consists of the adhesive composition according to the invention in the crosslinked state.

For the purposes of the present invention, the term “self-adhesive article” includes any article that can be adhesively bonded to a surface (or substrate) solely by the action of pressure with the hand or an item of equipment, without the use of additional glues or adhesives. Hence the self-adhesive article is also denoted by the term “pressure sensitive self-adhesive article”.

The carrier layer (b) coated with a self-adhesive layer (a) is also denoted by the term “self-adhesive carrier”. Said self-adhesive carrier possesses the desirable adhesive strength and tack. Moreover, the adhesive joint formed after application of said self-adhesive carrier to a substrate therefor provides for the securement of the carrier layer (b) in a temperature range of up to 200° C. and sometimes beyond.

These self-adhesive articles are intended particularly to be applied to a surface to be bonded so as to bring together, hold, secure, or simply immobilize, expose forms, logos, images or information. These articles may be used in many fields, such as the medical field, clothing, packaging, automobiles (for example for attaching logos, lettering, interior soundproofing, interior fitting, bonding in the passenger compartment) or construction (for example for sound and thermal insulation, the assembling of windows). They may be fashioned as a function of their final application, for example in the form of tapes, such as tapes for industrial use, tapes for do-it-yourself work or for securement use on worksites, single-sided or double-sided tapes, or in the form of labels, bandages, dressings, patches or graphic films.

According to one embodiment, the self-adhesive article is a self-adhesive multilayer system, and in particular a self-adhesive tape, which may be single-sided or double-sided, or else a label.

The material that can be used for the carrier layer (b) may be, for example, any type of rigid or flexible carrier. Examples that may be mentioned include supports of the type such as foams, felts, nonwoven supports, plastics, membranes, papers or a film of a polymer material with one or more layers, notably a nonstick protective paper or plastic film.

The carrier layer is made of material selected, for example, from polyolefins, such as polyethylene, including high-density polyethylene, low-density polyethylene, linear low-density polyethylene and linear ultra-low-density polyethylene; polypropylene and polybutylenes; polystyrene; natural or synthetic rubber; vinyl copolymers, such as polyvinyl chloride, plasticized or unplasticized, and poly(vinyl acetate)s; olefinic copolymers, such as ethylene/methacrylate copolymers, ethylene/vinyl acetate copolymers, acrylonitrile/butadiene/styrene copolymers, and ethylene/propylene copolymers; acrylic polymers and copolymers; polyurethanes; polyethers; polyesters; and mixtures thereof. The carrier layer is preferably based on acrylic polymers, polyethylene (PE), polypropylene (PP), which may be oriented, unoriented or biaxially oriented, polyimide, polyurethane, polyester such as polyethylene terephthalate (PET), or paper.

According to one preferred embodiment, the self-adhesive article further comprises a protective nonstick layer (c) (release liner) adjacent to the adhesive layer (a). The protective nonstick layer (c) can be easily removed without modifying the adhesive layer (a), which remains attached to the carrier layer (b).

According to a preferred variant, said layer (c) comprises a silicone-based material, said material either constituting said layer (c), or being present in the form of a surface coating of said layer (c), said coating being intended to be in contact with the adhesive layer (a).

According to a preferred variant of the self-adhesive article according to the invention, said article is packaged in the form of a winding around a reel (or roll), the dimensions of which can vary within a wide range. Thus, the diameter of such a roll may range from 0.25 to 1 m, and its width from 0.25 to 2 m.

According to this latter preferred variant, the protective nonstick layer (c) consists of the carrier layer (b) included in the self-adhesive article, wherein the face which is opposite the face in contact with the adhesive layer (a) is coated with a silicone-based material. A multilayer system of this kind, in which the protective nonstick layer (c) is not distinct from the layer (b), is sometimes denoted by the name “linerless”. Said packaging is particularly advantageous, because of its simplicity and the resulting economy, for converters who convert these roll stocks into self-adhesive tapes.

According to one embodiment, the self-adhesive article obtained from the adhesive composition according to the invention comprises a permanent carrier layer (b) coated with an adhesive layer (a).

According to a preferred variant of this embodiment, the permanent carrier layer (b) is coated on both faces with an adhesive composition, which may be identical or different, at least one of the two adhesive compositions being according to the invention, leading advantageously to the manufacture of “double-sided” tapes.

According to yet another embodiment, the self-adhesive article obtained from the adhesive composition according to the invention comprises a nonpermanent carrier layer (b) which consists of a first nonstick protective paper or plastic film (which is identical to the above-defined layer (c)), said layer (b) being coated with an adhesive layer (a) and likewise possibly being coated with a second nonstick protective paper or plastic film, which likewise is identical to the above-defined layer (c). This embodiment is particularly suitable for the assembly of windows by bonding, more particularly for the assembly of the rigid panel consisting of the double or triple glazing with the window frame. According to this embodiment, said nonpermanent carrier layer (b) is intended to be removed by the user at the time the self-adhesive article is used for the purpose of assembling the window.

The self-adhesive article according to the invention may bond two substrates. The substrate to which the self-adhesive article is intended to be applied (referred to as the “substrate to be bonded”) may be flexible or rigid. In particular, it may have the same flexibility properties as the carrier layer (b) described above, so as to be rolled up and packaged in the form of a reel, for example as described earlier.

Alternatively, the substrate to be bonded may be rigid. In this case, the substrate cannot be rolled up and packaged in the form of a reel, for example as described previously. The substrate to be bonded may be chosen, for example, from concrete, paper, substrates of polyolefin type, glass, ceramic and metals, notably aluminum.

The self-adhesive layer (a) consists of the adhesive composition according to the invention in the crosslinked state, and covers the carrier layer (b), in the self-adhesive article according to the invention. This layer (a) may have a very variable thickness of from 5 μm to 2000 μm, preferably from 10 μm to 1000 μm.

A thickness within a wide range of from 50 to 1000 μm is especially preferred for self-adhesive tapes, while a thickness of from 10 μm to 100 μm, preferably from 10 to 50 μm, is appropriate more particularly in the case of self-adhesive labels.

In turn, the carrier layer (b) has a thickness of from 10 microns to 50 mm, more preferably of from 10 microns to 20 mm, preferably of from 20 microns to 10 mm, more preferably of from 20 microns to 1 mm

Method for Manufacturing the Self-Adhesive Article:

The present invention further provides a method for manufacturing the self-adhesive article as defined previously, said method being characterized in that it comprises the sequential steps:
(i) of preheating the HMPSA composition according to the invention to a temperature of between 70 and 180° C., preferably between 110 and 140° C.;
(ii) of applying said composition by coating to a bearing surface;
(iii) of crosslinking said composition by UV irradiation to form the layer (a) of crosslinked adhesive composition; then
(iv) of laminating or transferring the layer (a) onto a carrier layer or onto a nonstick protective film.

Steps (i), (ii), (iii) and (iv) are implemented sequentially in the method according to the invention, although the inversion of steps (iii) and (iv) is not ruled out.

For the purposes of the present invention, the term “bearing surface” should be understood as meaning either a belt conveyor coated with a nonstick layer, or a nonstick protective film (c) (“release liner”), or a carrier layer (b).

In the case where the bearing surface is a nonstick protective film (c), the method for manufacturing the self-adhesive article according to the invention may comprise the step (iv) of transferring the crosslinked adhesive layer (a) onto a carrier layer (b).

In the case where the bearing surface is a carrier layer (b) or a nonstick protective film (c), the method for manufacturing the self-adhesive article according to the invention may also comprise the step (iv) of laminating the adhesive layer onto a nonstick protective film.

According to a preferred variant of the invention, step (iv) of the method described above entails transferring the crosslinked adhesive layer onto a flexible carrier layer (which may be a plastic film) after cooling of the crosslinked adhesive layer to a temperature below the degradation temperature or softening temperature of the material constituting the carrier layer.

According to one embodiment, the method for manufacturing the self-adhesive article according to the invention further comprises a step (v) of coating a second layer of adhesive composition according to the invention onto the carrier layer, followed by a step (vi) of crosslinking the adhesive composition coated in step (v) by UV irradiation. According to this embodiment, a double-sided self-adhesive article is obtained.

The coating step (ii) may be performed by means of known coating devices, for instance a lip nozzle or a nozzle of curtain type, or else with a roller. The surface weight of the HMPSA composition according to the invention in this step is from 5 g/m² to 2000 g/m², preferably from 10 g/m² to 1000 g/m².

The surface weight of adhesive composition required for the manufacture of self-adhesive labels may range from 10 to 100 g/m², preferably from 10 to 50 g/m². The surface weight required for the manufacture of self-adhesive tapes may vary preferably within a range extending from 50 to 1000 g/m², per face.

The effect of the UV irradiation step (iii) is to create—in particular via the pendant 1,2-vinyl group in the polymeric chains of the block copolymer (A)—carbon-carbon single bonds, which lead to the formation of a three-dimensional polymeric network in the adhesive layer (a).

This UV irradiation step is carried out by exposing the bearing surface coated with the HMPSA composition according to the invention to a UV source in the presence of air; said UV source may be a doped or undoped UV arc or microwave lamp, or else a UV LED. The UV source is capable of emitting radiation with a wavelength of from 200 nm to 500 nm. The radiation dose needed to crosslink the composition is dependent on a variety of factors, such as the power of the source, the quantity (or surface weight) of composition applied, and the nature and amount of the photoinitiator.

The time needed for the crosslinking in step (iii) may vary within wide limits, according to the power of the source and the surface weight of composition applied; for example, from less than 100 milliseconds to 10 minutes.

These various parameters are readily adjusted by those skilled in the art.

The present invention lastly provides a bonding method employing the self-adhesive article as defined earlier, characterized in that it comprises the following steps:

A) removing the nonstick protective layer, when such a layer is present;

B) applying the self-adhesive article to one surface of a product; and

C) applying a pressure to said article.

In step B), the self-adhesive article is applied so that the self-adhesive portion of the article (formed by the self-adhesive layer) is facing the surface of the product.

According to an embodiment in which the self-adhesive article is a double-sided article, the bonding method further comprises a step in which either a second surface of a product is applied to the article bonded to the first surface of a product, or the article bonded to the first surface of a product is applied to a second surface of a product.

The following examples are given purely by way of illustration of the invention and should not be interpreted so as to limit the scope thereof.

### EXAMPLE 1

1. Preparation of a UV-Crosslinkable HMPSA Composition:

The composition appearing in table 1 below is prepared by simple hot mixing at 165° C. of the ingredients indicated, with the photoinitiator (D) being added last. The Brookfield viscosity of this composition was measured at a temperature of 163° C. The result is indicated in table 2 in mPa·s.

2. Preparation of a Self-Adhesive Multilayer System Comprising a PET Carrier Layer (b) Coated with a Layer (a) Consisting of the Crosslinked HMPSA Composition and Having a Thickness of 60 μm:

A continuous laboratory coater operating at a line speed of about 15 m/minute is used, said coater being available from Acumeter Laboratory Inc. This coater is equipped in particular with a lip coating nozzle and a melting tank.

The carrier layer (b) is a PET film 50 μm thick, in the form of a strip 10 cm wide, packaged as a reel.

The nonstick protective film (c) used is a siliconized paper (obtained from Laufenberg), in the form of a strip 10 cm wide, packaged as a reel.

The HMPSA composition obtained above in 1. is heated in the melting tank to a temperature of 120° C. It is then coated in a surface weight of 60 g/m² onto the protective film (c), to form a layer 60 μm thick and 6 cm wide, centered on the corresponding strip of said film (c). Lastly, the applied nonstick protective film thus obtained is laminated onto the PET film.

Rectangular sheets with dimensions of 10 cm×20 cm are then cut from the resulting three-layer film, for exposure to a UV source. The UV lamp used is a Delolux 03S mercury UV lamp with a power of 400 W which is placed about 20 cm from the three-layer sheets.

UV irradiation is carried out with the three-layer sheets placed at a distance of about 20 cm from the lamp (PET layer facing the lamp) and exposed for a period of 5 to 30 seconds.

The self-adhesive article (or multilayer system) thus obtained is subjected to the tests described hereinafter.

180° Peel Test on a Stainless Steel Plate:

The adhesive strength is evaluated by the 180° peel test on a plate of stainless steel, as described in the FINAT No. 1 method, published in the FINAT Technical Handbook, 6th edition, 2001. FINAT is the International Federation of Self-Adhesive Label Manufacturers and Converters. The principle of this test is as follows:

A test specimen in the form of a rectangular strip (25 mm×175 mm) is cut from the self-adhesive multilayer system prepared in section 2. This test specimen is attached over half of its length (after removal of the corresponding portion of nonstick protective layer) to a substrate consisting of a plate of stainless steel. The assembly obtained is left at ambient temperature for 20 minutes. It is then placed in a tensile testing device capable, starting from the end of the rectangular strip which has remained free, of performing the peeling or detachment of the strip at an angle of 180° and with a separation speed of 300 mm per minute. The instrument measures the force required to detach the strip under these conditions.

The corresponding result is expressed in N/2.54 cm and indicated in table 2.

Instantaneous Adhesion Test (Also Known as the Loop Tack Test):

The tack, or immediate bonding strength, is evaluated by the “loop” test as described in the FINAT No. 9 method, the principle of which is as follows:

A test specimen in the form of a rectangular strip (25 mm×175 mm) is cut from the self-adhesive multilayer system prepared in section 2. After removal of all of the protective nonstick layer, the two ends of this strip are joined so as to form a loop with the adhesive layer facing outward. The two joined ends are placed in the movable jaw of a tensile testing device capable of imposing a displacement speed of 300 mm/minute along a vertical axis with a back-and-forth option. The lower part of the loop placed in the vertical position is first brought into contact with a horizontal stainless steel plate of 25 mm by 30 mm over a square region with a side length of approximately 25 mm Once this contact has been established, the direction of displacement of the jaw is reversed. The tack is the maximum value of the force required for the loop to become completely detached from the sheet.

The corresponding result is expressed in N/(2.54 cm)² and is indicated in table 2.

Temperature Causing Failure of the Bonded Joint with Static Shearing:

The high-temperature integrity of the adhesive strength of the self-adhesive multilayer system prepared in section 2 is evaluated by a test which determines the temperature causing failure of the bonded joint with static shearing. This test is also known under the name of Shear Adhesion Failure Temperature (SAFT) test.

For this test, reference is made to the FINAT No. 8 method. The principle is as follows:

A test specimen in the form of a rectangular strip (25 mm×75 mm) is cut from the self-adhesive multilayer system prepared in section 2. After removal of all of the protective nonstick layer, a square portion with a side length of 25 mm located at the end of the adhesive strip is attached to a plate of stainless steel.

The test plate thus obtained is introduced, by means of an appropriate support, in a substantially vertical position into an oven at a temperature of 20° C., the unbonded portion of the strip with a length of 50 mm being located below the plate. After thermal equilibration, the portion of the strip which has remained free is connected to a 500 g weight, the whole of the device always remaining in said oven throughout the duration of the test.

Under the effect of this weight, the bonded joint attaching the strip to the plate is subjected to a shearing stress. For more effective control of this stress, the test plate is in fact placed so as to form an angle of 2° relative to the vertical.

This oven is caused to undergo a programmed temperature rise at 0.4° C. per minute up to a maximum temperature of 200° C.

The temperature at which the strip falls off the plate following the failure of the bonded joint under the effect of this stress is recorded, and is reported in table 2.

No failure of the bonded joint is observed up to 200° C., which is the maximum temperature allowed by the oven's temperature rise programming, and consequently the result obtained is reported in table 2 as: “>200° C.”

### EXAMPLES 2 TO 8

Example 1 is repeated with the compositions indicated in table 1.

The results of the tests on the self-adhesive multilayer systems obtained are also indicated in table 2.

TABLE 1

| | | Amount in weight/weight % | | | | | | | |
|---|---|---|---|---|---|---|---|---|---|
| Ingredient | | Ex. 1 | Ex. 2 | Ex. 3 | Ex. 4 | Ex. 5 | Ex. 6 | Ex. 7 | Ex. 8 |
| (A) | Kraton ® D- | 15 | 15 | 15 | 17.6 | 14.8 | 19.1 | 23.3 | 19.1 |
| | KX222 | | | | | | | | |
| (B) | Regalite ® S1100 | 25.7 | 27.75 | 31.90 | 30.6 | 29.4 | 27.8 | 27.75 | 21.6 |
| | Regalite ® S5100 | 25.7 | 27.75 | 31.90 | 30.6 | 29.4 | 27.8 | 27.75 | 21.6 |
| (C) | Primol ® 352 | 18.6 | 18.6 | 18.6 | 18.6 | 18.6 | 18.6 | 18.6 | 18.6 |
| (D) | Omnirad ® BDK | 2.0 | 2.0 | 2.0 | 2.0 | 2.0 | 2.0 | 2.0 | 2.0 |
| (E) | Ricon ® 152 | 12.4 | 8.3 | 0 | 0 | 5.2 | 4.1 | 0 | 16.5 |
| (F) | Sumilizer ® GS | 0.4 | 0.4 | 0.4 | 0.4 | 0.4 | 0.4 | 0.4 | 0.4 |
| | Irgafos ® 168 | 0.2 | 0.2 | 0.2 | 0.2 | 0.2 | 0.2 | 0.2 | 0.2 |

TABLE 2

| | Ex. 1 | Ex. 2 | Ex. 3 | Ex. 4 | Ex. 5 | Ex. 6 | Ex. 7 | Ex. 8 |
|---|---|---|---|---|---|---|---|---|
| Brookfield | 703 | 810 | 830 | 1355 | 847 | 1545 | 3287 | 1327 |
| viscosity at | | | | | | | | |
| 163° C. (mPa·s) | | | | | | | | |
| 180° C. peel | 25.2 | 33.1 | 41.2 | 38.6 | 38.4 | 26.2 | 22.4 | 19.5 |
| (N/2.54 cm) | | | | | | | | |
| Tack | 35.6 | 47.6 | 14 | 43.2 | 44.5 | 28.3 | 34.1 | 22.7 |
| (in N/(2.54 cm)² | | | | | | | | |
| SAFT | >200 | 168 | 176 | >200 | >200 | 175 | >200 | 164 |
| (in ° C.) | | | | | | | | |

1.-12. (canceled)

13. A UV-crosslinkable hotmelt pressure sensitive adhesive (HMPSA) composition comprising, based on the total weight of said composition:
from 10% to 24% by weight of a block copolymer (A) which comprises at least:
a block A1 consisting of a repeating unit of aromatic hydrocarbon substituted by a vinyl group, and
a polybutadiene block A2 comprising at least 25% by weight of the 1,2-vinyl unit, based on the total weight of said polybutadiene block;
from 43% to 65% by weight of a tackifying resin (B) obtained by polymerization, then complete or partial hydrogenation of a petroleum-derived C9 fraction of unsaturated or aromatic hydrocarbons, said resin (B) having a softening point of from 80 to 150° C.;
from 10% to 25% by weight of a liquid plasticizer (C) comprising a petroleum-derived, completely or partially saturated hydrocarbon oil; and
an appropriate amount of a photoinitiator (D).

14. The HMPSA composition as claimed in claim 13, wherein the block copolymer (A) comprises 2 styrenic blocks A1 and the weight content of the 1,2-vinyl unit in the polybutadiene block A2 is within a range of from 30% to 70% by weight.

15. The HMPSA composition as claimed in claim 13, wherein the tackifying resin (B) has a softening temperature of between 90 and 120° C.

16. The HMPSA composition as claimed in claim 13, wherein the liquid plasticizer (C) comprises an oil having an average molecular mass as measured by the ASTM D 2502 method of less than or equal to 2000 g/mol.

17. The HMPSA composition as claimed in claim 13, further comprising up to 25% by weight of a liquid polybutadiene (E) of low molecular mass.

18. The HMPSA composition as claimed in claim 13, wherein it comprises:
from 12% to 19% by weight of the block copolymer (A);
from 50% to 65% by weight of the tackifying resin(s) (B); and
from 14% to 23% by weight of the liquid plasticizer (C).

19. A self-adhesive article comprising a carrier layer (b) coated with a self-adhesive layer (a), wherein said self-adhesive layer (a) comprises the adhesive composition as defined in claim 13, in the crosslinked state.

20. The self-adhesive article as claimed in claim 19, wherein the article is a single-sided or double-sided self-adhesive tape.

21. The self-adhesive article as claimed in claim 19, wherein the article further comprises a nonstick protective layer (c) adjacent to the adhesive layer (a).

22. The self-adhesive article as claimed in claim 19, wherein the thickness of the layer (a) is from 5 μm to 2000 μm.

23. A method for manufacturing the self-adhesive article as defined in claim 19, said process comprising the sequential steps:
i. of preheating the HMPSA composition to a temperature of between 70 and 180° C.;
ii. of applying said composition by coating to a bearing surface;
iii. of crosslinking said composition by UV irradiation to form the layer of crosslinked adhesive composition (a); then
iv. of laminating or transferring the layer (a) onto a carrier layer or onto a nonstick protective film.

24. A bonding method employing the self-adhesive article as defined in claim 19, comprising the following steps:
A. removing the nonstick protective layer, when such a layer is present;
B. applying the self-adhesive article to one surface of a product; and
C. applying a pressure to said article.
